(19) United States
(12) Patent Application Publication
(10) Pub. No.: US 2016/0210313 A1
(43) Pub. Date: Jul. 21, 2016

(54) SYSTEM FOR HIGH-THROUGHPUT HANDLING OF TRANSACTIONS IN A DATA-PARTITIONED, DISTRIBUTED, RELATIONAL DATABASE MANAGEMENT SYSTEM

(71) Applicant: Futurewei Technologies, Inc., Plano, TX (US)

(72) Inventors: Mengmeng CHEN, San Jose, CA (US); Masood MORTAZAVI, San Jose, CA (US); Ron Chung HU, Palo Alto, CA (US)

(21) Appl. No.: 14/599,043

(22) Filed: Jan. 16, 2015

(51) Int. Cl. G06F 17/30

(52) U.S. Cl. CPC G06F 17/30289; G06F 17/30595

(57) ABSTRACT

The present invention is directed to a novel, a topic-based messaging architecture (including schema, protocols, naming conventions, etc.) to be used in a distributed data-oriented OLTP environment. According to an aspect of the claimed subject matter, the topic-based messaging architecture can be implemented as a type of publication-subscription (“pub-sub”) messaging pattern. In one or more embodiments of the topic-based system, messages are published to “topics,” or named logical channels. Subscribers in a topic-based system will receive all messages published to the topics to which they subscribe, and all subscribers to a topic will receive the same messages. The publisher is responsible for defining the classes of messages to which subscribers can subscribe. The topic-based messaging interface improves the scalability of a distributed database management system and provides a robust mechanism for message delivery.

### BACKGROUND OF THE INVENTION

The development of hardware technologies—computer processing and storage capabilities, specifically—have contributed to the proliferation of electronic databases and database management systems (DBMS) in nearly every business and industry. Databases have become indispensable for storing, manipulating, and processing collections of information. Typically, one or more units of data collected in a database are accessed through a transaction. Access is performed by one or more processes, which can be dedicated transaction processing threads. Issues arise when data must be accessed concurrently by several threads.

In conventional database management systems, the access patterns of each transaction, and consequently of each thread, are arbitrary and uncoordinated. To ensure data integrity, each thread enters a one or more sections in the lifetime of each transaction it executes. To prevent corruption of data, logical locks are applied to a section when a thread accesses the section, so that no other thread is allowed to access the section while the current thread is processing. Critical sections, however, incur latch acquisitions and releases, whose overhead increases with the number of parallel threads. Unfortunately, delays can occur in heavily-contended critical sections, with detrimental performance effects. The primary cause of the contention is the uncoordinated data accesses that is characteristic of conventional transaction processing systems. Because these systems (typically) assign each transaction to a separate thread, threads often contend with each other during shared data accesses.

To alleviate the impact of applying logical locks to entire sectors of data, the sectors of data may be partitioned into smaller sections. Each “lock” applies only to the particular partition a thread is manipulating, leaving the other partitions free to be accessed by other threads performing other transactions. The lock manager is responsible for maintaining isolation between concurrently-executing transactions, providing an interface for transactions to request, upgrade, and release locks. However, as the number of concurrently-executing transactions increases due to increasing processing capabilities, in typical transaction processing systems the centralized lock manager is often the first contended component and scalability bottleneck.

Under a recently proposed alternative (Data Oriented Architecture) to the contention issue, rather than coupling each thread with a transaction, one solution is to couple each thread with a disparate subset of the database. Transactions flow from one thread to the other as they access different data. Transactions are decomposed to smaller actions according to the data they access, and are routed to the corresponding threads for execution. Under such a scheme, data objects are shared across actions of the same transaction in order to control the distributed execution of the transaction and to transfer data between actions with data dependencies. These shared objects are called “rendezvous points” or “RVPs.” If there is data dependency between two actions, an RVP is placed between them. The RVPs separate the execution of the transaction to different phases. The system cannot concurrently execute actions from the same transaction that belong to different phases.

However, while the proposed alternative offers a solution to contention-related delays, such a solution is directed to data storage implementations in which the processors are tightly coupled and constitute a single database system, and is unsuitable and/or sub-optimal for distributed databases, in which the storage devices are not all attached to a common processing unit such as a CPU, may be stored in multiple computers dispersed over a network of interconnected computers.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is directed to a novel, a topic-based messaging architecture (including schema, protocols, naming conventions, etc.) to be used in a distributed data-oriented OLTP environment. According to an aspect of the claimed subject matter, the topic-based messaging architecture can be implemented as a type of publication-subscription (“pub-sub”) messaging pattern.

In one or more embodiments of the topic-based system, messages are published to “topics,” or named logical channels. Subscribers in a topic-based system will receive all messages published to the topics to which they subscribe, and all subscribers to a topic will receive the same messages. The publisher is responsible for defining the classes of messages to which subscribers can subscribe. The topic-based messaging interface improves the scalability of a distributed database management system and provides a robust mechanism for message delivery. With the use of topic-based messaging on a distributed data-oriented architecture, two major factors contribute to the increase of system throughput, namely removal of lock contentions and delegating communication messages to a separate message system. Both factors can significantly reduce CPU workload so that the CPUs of database nodes can focus on performing useful database work. That said, the throughput of a distributed data-oriented transaction processing system is therefore improved dramatically, and the system is able to perform transactions on a larger, distributed scale.

According to an aspect of the claimed subject matter, a method is provided for performing database transactions in an online distributed database system. In an embodiment, database transactions may be performed by receiving a data-oriented transaction from a client device, generating a commit channel and transaction plan for the transaction in a coordinator, identifying corresponding logic channels from an existing plurality of logic channels, and subscribing processing threads mapped to the logic channels to the commit channel. Thereafter, instructions and notifications are published from the coordinator to the commit channel, and relayed to subscribing threads. Database actions are performed by the threads according to the published instructions, and the completion of the actions is published to the coordinator and the commit channel (and subscribers to the commit channel thereafter).

In one or more embodiments, a transaction plan includes multiple database actions distributed among a plurality of phases, the completion of the actions of a phase is tracked at various serialization points which separate the phases, and signals the completion of the current phase. Database actions performed in the same phase may be performed in parallel or substantially in parallel, and the completion of all phases in a transaction concludes the transaction. In one or more further embodiments, the completion of all phases prompts a two-phase commit protocol to be performed by the coordinator, that may include sending a query to the processing threads for a commit or rollback vote. If all processing threads return a vote to commit, results from the performance of the database actions are committed to the database nodes and the transaction is complete.

According to the embodiments of the claimed subject matter described herein, a high-throughput, distributed, multi-partition transaction system is achieved with high performance, throughput, audit, debugging and monitoring properties. In addition, a loosely coupled distributed system of processing units with internal, data-oriented transaction management mechanisms already in place may be achieved. Additional advantages and features of the invention will become apparent from the description which follows, and may be realized by means of the instrumentalities and combinations particular point out in the appended claims.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a block diagram of an exemplary topic-based messaging architecture in a distributed database system, in accordance with embodiments of the present invention.

FIG. 2 depicts a block diagram of an exemplary publication/subscription data flow diagram in a distributed database system, in accordance with embodiments of the present invention.

FIG. 3 depicts a block diagram of an exemplary execution plan of a transaction distributed across a plurality of phases, in accordance with embodiments of the present invention.

FIG. 4 depicts an exemplary data structure representing a summary of topics, in accordance with embodiments of the present invention.

FIG. 5 depicts a timing graph of an exemplary transaction distributed across a plurality of phases, in accordance with embodiments of the present invention.

FIG. 6 depicts an exemplary flowchart of a process for performing database transactions in an online distributed database system, in accordance with embodiments of the present invention.

FIG. 7 depicts an exemplary general computing environment upon which embodiments of the present invention may be executed.

### DETAILED DESCRIPTION

Reference will now be made in detail to the preferred embodiments of the claimed subject matter, a method and system for the use of a radiographic system, examples of which are illustrated in the accompanying drawings. While the claimed subject matter will be described in conjunction with the preferred embodiments, it will be understood that they are not intended to limit these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, components, and circuits have not been described in detail as not to obscure unnecessarily aspects of the claimed subject matter.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “storing,” “creating,” “protecting,” “receiving,” “encrypting,” “decrypting,” “destroying,” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

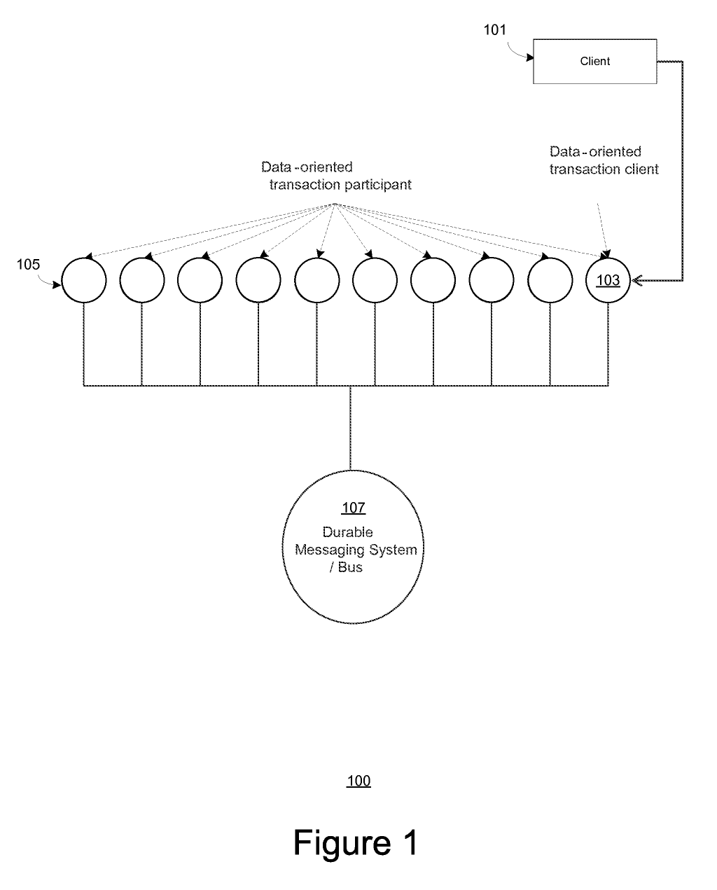

Accordingly, embodiments of the claimed subject matter provide a topic-based messaging architecture to be used in a distributed data-oriented environment, such as an online transaction processing (OLTP) system. According to an embodiment, the topic-based messaging architecture may include a coordinator communicatively coupled to one or more distributed databases by a publication/subscription message bus. FIG. 1 depicts an exemplary configuration 100 of such an architecture.

As depicted in FIG. 1, a transaction 101 is received in a transaction coordinator 103. In one or more embodiments, the transaction may be implemented as an SQL request from a client device. The transaction coordinator may, for example, be implemented as a computing device, such as a web host and/or server. The transaction may be performed in data stored in one or more database nodes. These nodes may comprise distributed (remotely-located) computing devices, each storing one or more sections (partitions) of data. In alternate embodiments, the nodes may comprise co-located but disparate computing systems, or a combination of both remote and co-located computing systems.

Performance of the actions that comprise the data transaction are performed in data-oriented transaction participants (105), which in one or more embodiments, may be implemented as processing threads corresponding to, and executing in, the one or more database nodes. In a further embodiment, each processing thread is exclusively responsible for performing the actions on the partition of the data corresponding to the processing thread. Each thread may be implemented as an (action) enqueue thread, wherein new actions to be performed are appended to the end of the enqueue thread, and the thread performs the actions in the order received.

In one or more embodiments, the architecture 100 is implemented as topic-based system. Under such an embodiment, communication (messages) between the coordinator are published to “topics” or named logical channels through a messaging system (e.g., bus 107). The logical channels may correspond with to a particular class. For example, a class may correspond to a specific partition, data entity, or other association or identification with the system. The data-oriented transaction participants can subscribe to one or more logical channels, and subscribers in the system will receive all messages published to the topics to which they subscribe, with each subscribers to a topic receiving the same messages. The publisher is responsible for defining the classes of messages to which subscribers can subscribe.

Likewise, when actions are performed by the processing threads, notification may be published to the coordinator (and other subscribed threads) through the messaging bus 107 by the processing thread 105. In one or more embodiments, a transaction is performed once all sub-actions are performed by the data-oriented transaction participants (105) and a two-phase commit protocol is performed to verify completion of the transaction.

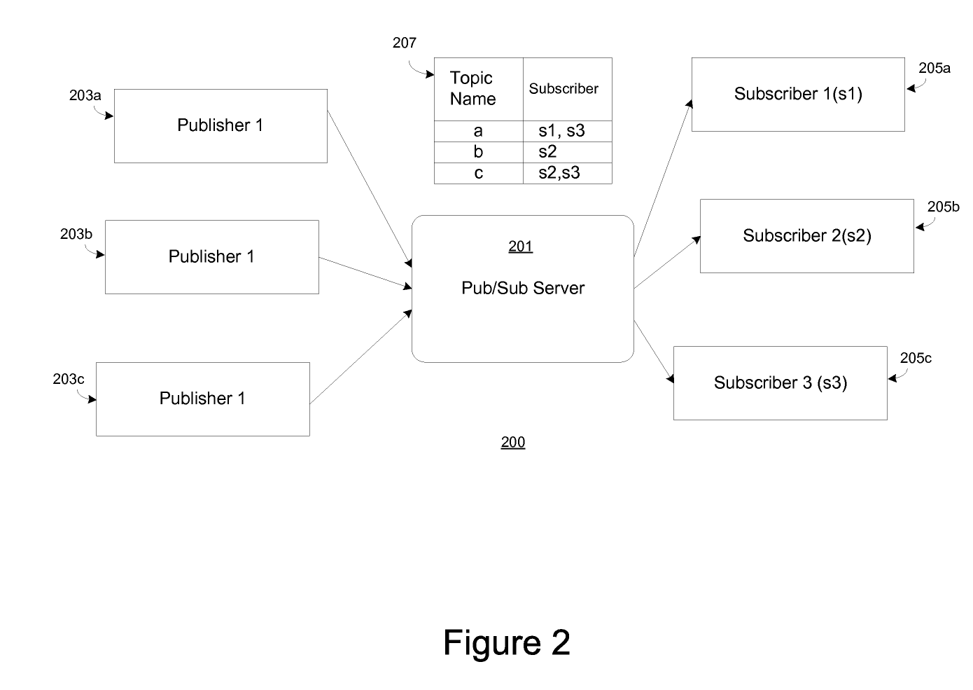

FIG. 2 depicts an exemplary publication/subscription data flow diagram 200 in a distributed database system. As depicted in FIG. 2, the coordinator of the topic-based messaging architecture described above with respect to FIG. 1 may be implemented as, or to include, a publication/subscription server (201). As depicted in FIG. 2, one or more message publishers (e.g., 203a, 203b, 203c) publish messages, which are received in the publication/subscription server 201. These messages may include, for example, the completion of one or more actions performed by a processing thread (data-oriented transaction participant) in a transaction.

In one embodiment, the publication/subscription server receives messages sent by a publisher (e.g., through a messaging bus), and identifies (or is provided with) the topic or logic channel the message corresponds to. Subsequently, the publication/subscription server references a table 207 mapping the logic channels to associated subscribers to determine which subscribers are subscribed to the logic channel of the message. The message is then relayed directly to the identified subscribers via the message bus coupling the server 201 to the subscribers (205a, 205b, 205c), while avoiding the nodes/threads that are not subscribed to the message channel.

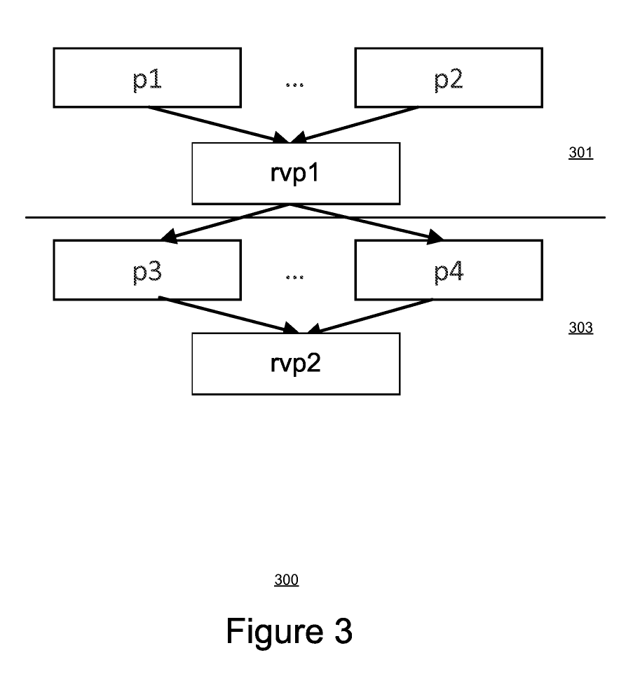

According to one or more embodiments, a client request or transaction may be executed as a series of “steps,” or phases each of which contains multiple ‘actions’ that can be scheduled to run in parallel, and with dependency on actions in a previous phase. FIG. 3 depicts a typical execution plan 300 for a transaction. As depicted in FIG. 3, an execution plan for a transaction may include a plurality of actions (p1, p2, p3, p4) distributed in a series or sequence of phases (301, 303). In one or more embodiments, actions distributed in the same phase (e.g., p1 and p2 in 301, p 3 and p4 in 303) can be executed in parallel by the corresponding processing threads.

Where a dependency arises between two or more actions, a serialization point (rvp1) is created and executed in between the two phases. Thus for example, if action p3 depends on the processing of action p1, and action p4 depends on the processing of p2, p3 and p4 would not start until the completion of p1 and p2, which is verified and communicated (published) at the serialization point rvp1. Publication of the completion of the actions in phase 1 (301) at serialization point rvp1 concludes phase 1, and phase 2 commences once the notification is published to the threads processing p3 and p4.

According to one or more embodiments, the enqueue of the action in a distributed environment is accomplished by sending messages to the specific threads that correspond to p1 p2 and p3, p4, respectively. In the final serialization point, (rvp2 as depicted in FIG. 3), a two-phase commit (2PC) is performed, since the involved threads might be located in different nodes. According to one or more embodiments, the number of phases and the number of serialization points can be any arbitrary number, not limited to the depictions described herein. According to one or more further embodiments, a transaction plan can correspond to an organization of database actions performed among any of an arbitrary number of partitions, each with its own corresponding sequence of phases and serialization points.

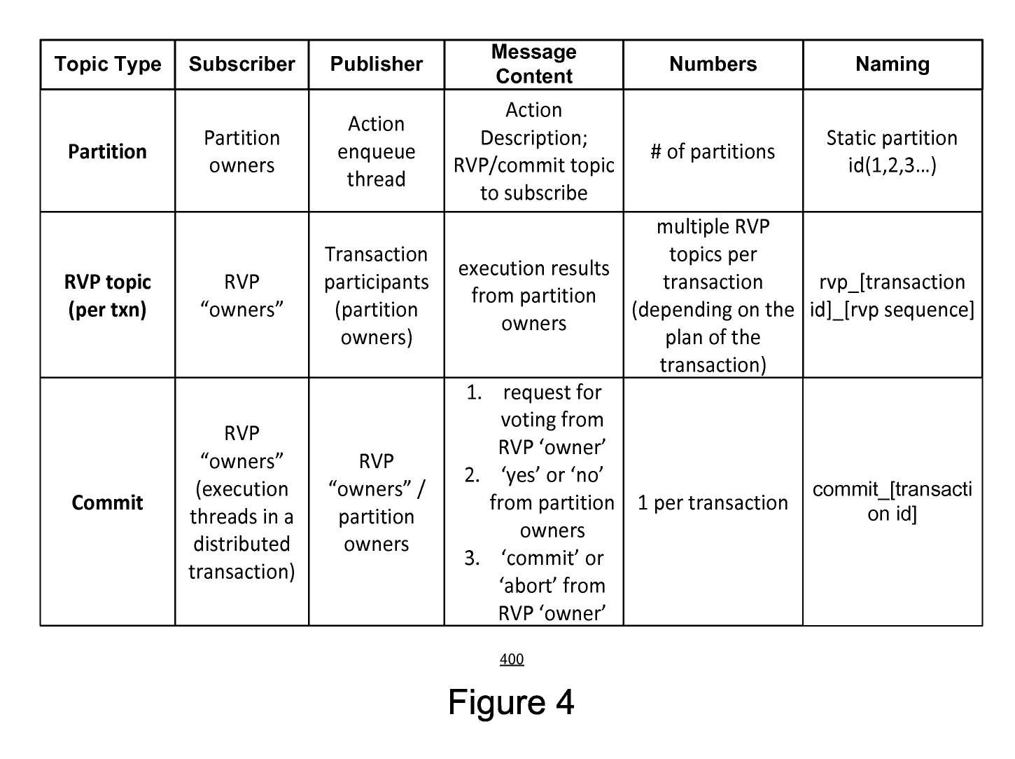

FIG. 4 depicts an exemplary data structure 400 comprising a summary of topics. In one or more embodiments, the summary of topics may represent a partition and the entities corresponding to the partition. As depicted in FIG. 4, data structure 400 may be implemented as a table or chart that describes the characteristics of topics in the database and corresponding entities. In one or more embodiments, the data structure 400 may be automatically generated (e.g., by a client coordinator, or the node corresponding to the partition). In one or more embodiments, data structure 400 organizes data in the partition according to the various classes. As presented in FIG. 4, the classes may include: “topic type,” “subscriber,” publisher,” “message content,” numbers,” and “naming.”

Topic type classifies the topic of a data transaction. As depicted in FIG. 4, the topic type may correspond to one of types: 1) Partition, corresponding to the entire data partition; 2) RVP topic, corresponding to a serialization point for a transaction; and 3) a commit topic, corresponding to a topic for publishing the completed performance of database actions.

As presented in FIG. 4, the subscriber for a partition is the partition owner. Owners of topics according to FIG. 4 are the entities with access to read and write for the particular topic. In one or more embodiments, the partition owner is the processing thread in the node that performs the database actions. In alternate embodiments, the database management system itself may be the owner of the partition. Publishers on the partition topic include the action enqueue thread (processing thread), and the content of messages published to the partition may include a description of the action, and the names/identities of the serialization and commit topics that are to subscribe to the partition topic. The number of partitions corresponds naturally to the number of nodes in the database, and the partition may be named within the database system using a static partition identification number, according to one or more embodiments.

For a serialization point topic (a.k.a. RVP topic), subscribers are the owners of the serialization point, which may include the processing threads of the partitions in which database actions are performed for the phase of a given transaction corresponding to the serialization point. Publishers to the thread are the transaction participants—likewise, the partition owners. A message published to the serialization topic includes execution results from partition owners for database actions performed in the partition during the phase corresponding to the serialization point. There can be multiple serialization point topics for each transaction, depending on the transaction plan, and the serialization topic may be identified within the database management system with a specific nomenclature that includes an indication of the topic as a serialization point, along with a transaction id and the position in the sequence corresponding to the serialization point.

For a commit topic, subscribers are the owners of the serialization point corresponding to the commit topic, typically the execution threads. Publishers to the commit topic include the owners of the serialization point and the partition owners. Message contents for messages published in a commit channel may include requests for voting (e.g., at the initiation of a commit action) published by a serialization point owner. Other message contents may include a response from the partition owners in response to the request for vote, and a disposition from the serialization point owner based on the received responses (e.g., either to commit the database action results or to abort the performed actions). There is one commit topic for each transaction, and a commit topic is identified with a commit prefix (with a transaction id) within the database management system.

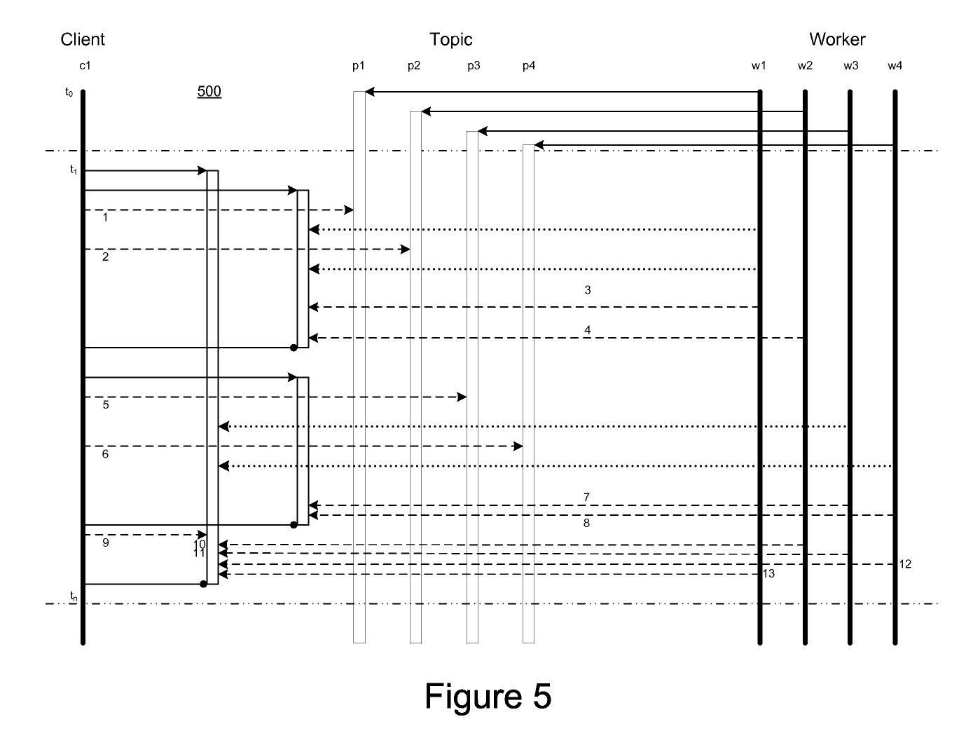

FIG. 5 depicts a timing graph 500 of an exemplary transaction distributed across a plurality of phases, in accordance with embodiments of the present invention. FIG. 5 depicts an exemplary chronology of events that may be performed during a transaction. As depicted in FIG. 5, one or more logic channels, or “topics” may be generated at some time t₀. The logic channels may be generated by a coordinator, for example. One or more processing/execution threads or “workers” (e.g., worker w1, w2, w3, and w4) may be subscribed (indicated by the solid black line) to a corresponding topic, e.g., w1 to p1, w2 to p2, w3 to p3, and w4 to p4, respectively.

At time t₁, a transaction request is issued from a client. The transaction request is received (in a coordinator, for example), and a commit channel/topic is generated by the coordinator. In one or more embodiments, a commit channel may be re-allocated from pre-existing commit channels which have been closed (due to disuse, for example). The coordinator determines associated logic channels, and a execution plan for the transaction. A typical execution plan according to one or more embodiments may include one or more database actions performed over one or more phases, wherein a database action with a dependency on another database action is distributed to a different (subsequent) phase. Phases conclude when database actions in that phase are performed, and verified as performed at a serialization point. Once the execution plan is determined, the coordinator generates serialization points as necessary. For example, as depicted in FIG. 5, the transaction includes two phases, and a serialization point (RVP 1, RVP 2) is generated for each phase.

Once the first serialization point is generated, database actions (numbered 1-13) may be performed. The coordinator determines the logic channels that correspond to the commit channel, and publishes notification of the correspondence to the particular logic channels. Publications are indicated by dashed lines and subscriptions are indicated by dotted lines in FIG. 5. At Action 1, for example, the coordinator publishes the association of the commit channel to channel p1, which is received by the worker (w1) subscribed to channel p1. The worker w1 is thereafter subscribed to the commit channel. Similarly, the coordinator publishes the association of the commit channel to channel p2, which is received by the worker (w2) subscribed to channel p2 at Action 2. The worker w2 is thereafter subscribed to the commit channel.

In one or more embodiments, instructions to perform database actions may be sent to the workers along with the published notifications, or separately/subsequently. Once the database actions are performed, the processing thread publishes notification of the completion of its respective database action to the coordinator (at Actions 3 and 4, respectively). Intermediate results are collected at the serialization point of the first phase. As depicted in FIG. 5, the reception of the intermediate results at the serialization point concludes the first phase, and the second serialization point is generated.

Thereafter, the coordinator publishes the association of the commit channel to channels corresponding to the second phase. As depicted in FIG. 5, publication is received in logic channel p3, which is received by the worker (w3) subscribed to channel p3 at Action 5; and in logic channel p4, which is received by the worker (w4) subscribed to channel p4 at Action 6. Workers w3 and w4 are thereafter subscribed to the commit channel.

Likewise with respect to phase 1, instructions to perform database actions may be sent to the workers corresponding to phase 2 along with the published notifications, or separately/subsequently. The database actions are performed by the corresponding thread, and the processing thread publishes notification of the completion of its respective database action to the coordinator (at Actions 7 and 8, respectively). Intermediate results from phase 2 are collected at the serialization point of the second phase. The reception of the intermediate results at the serialization point of phase 2 concludes the second phase.

If the execution plan does not include additional phases, a two-phase commit is performed to validate the actions performed during the transaction. In one or more embodiments, the execution plan includes a request for vote (Action 9), initiated by the coordinator, and distributed to the subscribers (in this case, all processing threads involved in the transaction) to the commit channel. If a worker/processing thread is able to confirm completion of the database actions the thread was responsible for performing, the thread publishes a vote to commit (Actions 10, 11, 12, 13 from workers w3, w2, w4, and w1, respectively). If a vote for commit is received by the coordinator from every processing thread, the results collected at the last serialization point is committed (i.e., distributed to each data node and partition), and the transaction is completed. Thereafter, the commit channel may be de-allocated. In alternate embodiments, the commit channel may be re-used for subsequent transactions. In the alternative, if a processing thread has not completed its database action, or otherwise encounters an error, a rollback vote may be received, wherein the transaction may be re-attempted using the data in the database when the transaction commenced.

While depicted with four commit topics, it is to be understood that the depiction is for exemplary purposes only, and not to be construed as being limited to such (or any) amount. Indeed, the present invention is well suited to alternate embodiments that include any number of an arbitrary number of topics, for any number of an arbitrary number of phases, separated by any number of an arbitrary number of serialization points. Moreover, while FIG. 5 depicts a transaction plan that includes a partition, one or more embodiments of the present invention are well suited to a transaction plan as depicted in FIG. 5 and described herein performed in parallel and/or in sequence among a plurality of partitions.

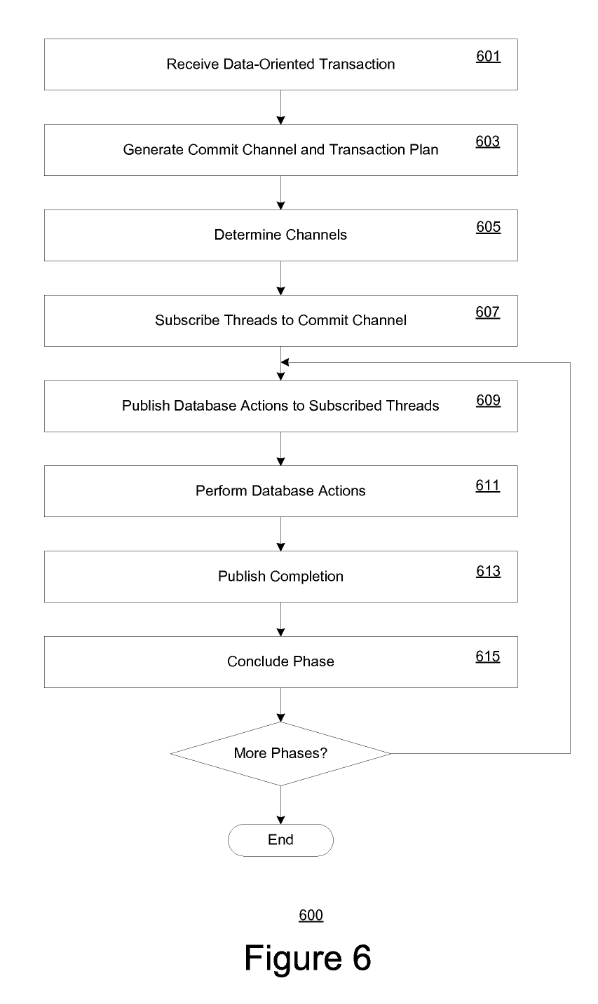

FIG. 6 depicts a process 600 for performing database transactions in an online distributed database system. Steps 601 to 615 describe exemplary steps comprising the process 600 depicted in FIG. 6 in accordance with the various embodiments herein described. In one embodiment, the process 600 is implemented in whole or in part as computer-executable instructions stored in a computer-readable medium and executed by a processor in a computing device.

As depicted in FIG. 6, performance of database transaction begins by receiving a data-oriented transaction from a client device at step 601. In one or more embodiments, the client device comprises a computing device, such as a personal computer or laptop, and the database transaction may be implemented as, or include, a database request such as a Structure Query Language (SQL) request. The database request may be received in a coordinator, implemented as a module or application executing in a networked, computing device, which may be remotely located from the client computing device.

At step 603, the coordinator generates a commit channel and transaction plan for the transaction. In one or more embodiments, the transaction plan includes the database actions and the identification of the networked database nodes (and corresponding processing threads) for which the database actions is to be performed. In further embodiments, the transaction plan includes a sequence of phases, and a distribution of the database actions among the sequence of phases. Serialization points that collect intermediate results between phases may also be generated at step 603.

At step 605, logic channels from an existing plurality of logic channels that correspond to the commit channel are identified by the coordinator, and processing threads mapped to the identified logic channels are subscribed to the commit channel at step 607. In one or more embodiments, the processing threads are identified by referencing a mapping of subscriptions stored in the coordinator. Once the processing threads are subscribed to the commit channel, instructions and notifications are published from the coordinator to the commit channel, and relayed to subscribing threads at step 609. In one or more embodiments, messages (including publications and subscriptions) are performed in a persistent publication/subscription message bus that communicatively couples the coordinator with the database nodes (and processing threads).

At step 611, database actions are performed by the threads according to the published instructions, and once completed, the completion of the actions is published to the coordinator and the commit channel (and subscribers to the commit channel thereafter) at step 613, each through the message bus. The completion of all database actions in a phase concludes a phase (step 613). If subsequent phases are required according to the execution plan, steps 609 through 615 are repeated until no subsequent phases are necessary. In one or more further embodiments, the completion of all phases prompts a two-phase commit protocol to be performed by the coordinator, that may include sending a query to the processing threads for a commit or rollback vote. If all processing threads return a vote to commit, results from the performance of the database actions are committed to the database nodes and the transaction is complete.

In one or more embodiments, database actions in the same phase may be performed in parallel, while the database actions with dependencies on one or more other database actions are distributed in later phases from the database actions depended upon. The completion of the actions of a phase is tracked at various serialization points which separate the phases, and signals the completion of the current phase. Database actions performed in the same phase may be performed in parallel or substantially in parallel, and the completion of all phases in a transaction concludes the transaction.

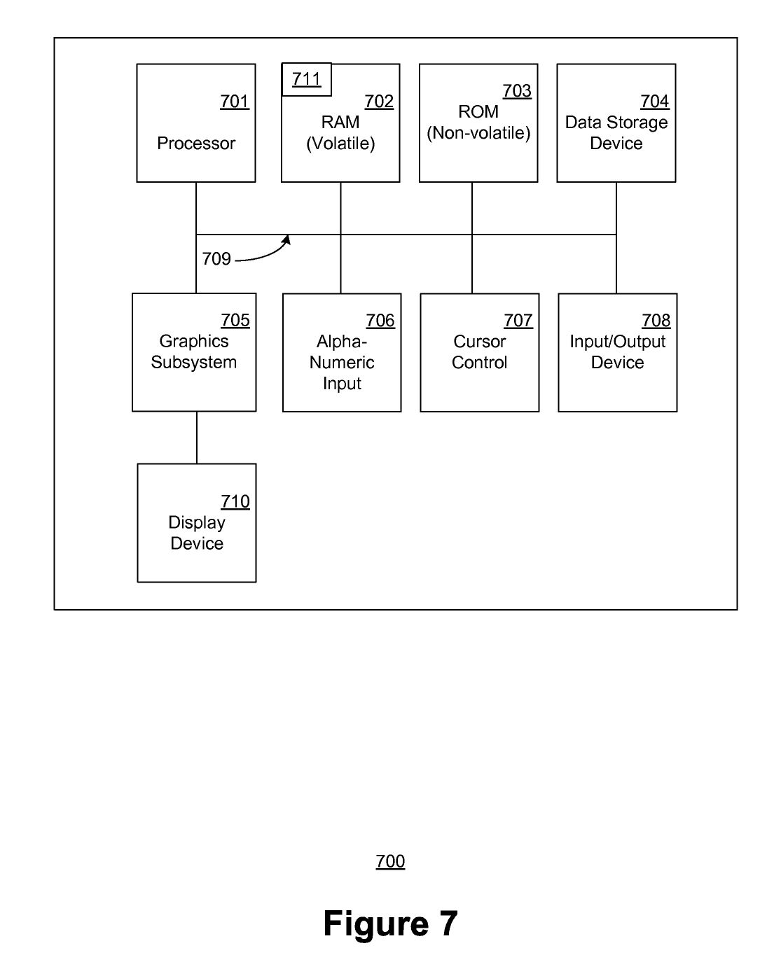

As presented in FIG. 7, an exemplary computing environment 700 is depicted, in accordance with embodiments of the present disclosure. In its general configuration, computing environment 700 typically includes at least one processing unit 701 and memory, and an address/data bus 709 (or other interface) for communicating information. Depending on the exact configuration and type of computing environment, memory may be volatile (such as RAM 702), non-volatile (such as ROM 703, flash memory, etc.), some combination of volatile and non-volatile memory, or other suitable device capable of storing for subsequent recall data and/or instructions executable on the processing unit 701. According to one or more embodiments, programmed instructions 711 stored in the memory of computing environment 700 may be executed by the processing unit 701 to perform coordination for data-oriented transactions in a database of distributed among a plurality of partitions.

In some embodiments, computing environment 700 may also comprise an optional graphics subsystem 705 for presenting information to a user, e.g., by displaying information on an attached or integrated display device 710. Additionally, computing system 700 may also have additional features/functionality. For example, computing system 700 may also include additional storage (removable and/or non-removable) including, but not limited to, magnetic or optical disks or tape. Such additional storage is illustrated in FIG. 7 by data storage device 704. Computer storage media includes volatile and nonvolatile, removable and non-removable media implemented in any method or technology for storage of information such as computer readable instructions, data structures, program modules or other data. RAM 707, ROM 703, and data storage device 704 are all examples of computer storage media.

Computing environment 700 may also comprise a physical (or virtual) alphanumeric input device 706, an physical (or virtual) cursor control or directing device 707. Optional alphanumeric input device 706 can communicate information and command selections to central processor 701. Optional cursor control or directing device 707 is coupled to bus 709 for communicating user input information and command selections to central processor 701. As shown in FIG. 7, computing environment 700 also includes one or more signal communication interfaces (input/output devices, e.g., a network interface card) 707. The signal communication interface may function to receive user input for the computing environment 700, and/or allow the transmission and reception of data with one or more communicatively coupled computing environments.

In the foregoing specification, embodiments have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A computing device for executing data-oriented transactions in a distributed, multi-partition data management system, the computing device comprising:
a memory operable to store a plurality of programmed instructions;
a processor configured to execute the plurality of programmed instructions to perform data-oriented transactions by generating an execution plan for performing database actions in a database stored across a plurality of partitions comprised in a plurality of remote computing devices, allocating a commit channel for database action instructions, and determining a logic corresponding to the commit channel, the logic channel being mapped to at least one remote computing device of the plurality of remote computing devices; and
a message bus communicatively coupling the computing device with the plurality of remote computing devices,
wherein the processor is further configured to identify and distribute instructions to perform a database action to the at least one remote computing device based on the logic channel,
wherein the execution plan organizes the database actions among a plurality of phases separated by a plurality of synchronization points,
further wherein database actions corresponding to a same phase of the plurality of phases are performed in parallel with results from each phase of the plurality of phases being collected at a synchronization point of the plurality of synchronization points corresponding to the phase.

2. The computing device of claim 1, wherein the processor is further configured to receive a transaction request from a client computing device, to generate a new commit channel based on the transaction request, to determine a subset of logic channels that corresponds to the new commit channel, and to distribute notifications of database actions performed corresponding to the commit channel to remote computing devices of the plurality of remote computing devices corresponding to the subset of logic channels.

3. The computing device of claim 1, wherein the computing device comprises a publish/subscribe server.

4. The computing device of claim 1, wherein the processor is further configured to distribute instructions to perform a database action by appending the instructions to an action enqueue thread corresponding to a remote computing device.

5. The computing device of claim 1, wherein a database action of the plurality of database actions is performed via a two-phase commit protocol.

6. The computing device of claim 1, wherein generating the commit channel comprises reallocating a previously-generated commit channel from a pool of previously-generated commit channels.

7. The computing device of claim 1, wherein a synchronization point of the plurality of synchronization points comprises a previously-generated synchronization point comprised in a pool of previously-generated synchronization points.

8. The computing device of claim 1, wherein the message bus comprises a publication/subscription message bus.

9. A method comprising:
a) receiving, in first computing device, a data-oriented transaction from a client computing device;
b) generating a commit channel and an execution plan for the transaction, the execution plan comprising a plurality of database actions organized into a plurality of phases separated by a plurality of synchronization points,
c) determining a subset of channels corresponding to the commit channel from a plurality of pre-existing channels;
d) subscribing a first plurality of processing threads to the commit channel such that the first plurality of processing threads is configured to receive notifications of database actions corresponding to the commit channel to be performed by the first plurality of processing threads, the first plurality of processing threads corresponding to a first phase of the plurality of phases and being mapped to a plurality of remotely-located computing devices;
e) publishing a set of database actions from the plurality of database actions to be performed by the first plurality of processing threads;
f) receiving notifications of the performance, in parallel, of a first set of database actions of the plurality of database actions corresponding to the first phase on a first data partition of the plurality of data partitions;
g) publishing, via the message bus, a completion of the first set of actions to the commit channel; and
h) terminating the first phase in response to the completion of the first set of actions.

10. The method of claim 9, further comprising:
i) receiving intermediate data resulting from the completion of the first set of actions;
j) subscribing a second plurality of processing threads to the commit channel such that the second plurality of processing threads is configured to receive notifications of database actions corresponding to the commit channel to be performed by the second plurality of processing threads, the second plurality of processing threads corresponding to a second phase of the plurality of phases,
k) publishing, via a message bus communicatively coupling the coordinator with the plurality of remotely-located computing devices, a set of database actions from the plurality of database actions to be performed by the second plurality of processing threads;
l) receiving notifications of the performance, in parallel, of a second set of database actions of the plurality of database actions corresponding to the second phase on a second set of data partitions of the plurality of data partitions;
m) publishing, via the message bus, a completion of the second set of actions to the commit channel; and
n) terminating the second phase in response to the completion of the second set of actions.

11. The method of claim 10, further comprising performing steps i)-n) for any number of synchronization points of the plurality of synchronization points, any number of phases of the plurality of phases corresponding to the data-oriented transaction, and any number of partitions of the plurality of partitions.

12. The method of claim 9, further comprising performing, in response to publishing the completion of the second set of actions, a two-phase commit of the plurality of database actions.

13. The method of claim 12, wherein performing a two-phase commit of the plurality of database actions comprises querying the plurality of processing threads to determine the completion of the plurality of database actions.

14. The method of claim 9, wherein receiving a data-oriented transaction from a client computing device comprises generating an execution plan in the first computing device, the execution plan defining the plurality of phases and the plurality of synchronization points.

15. The method of claim 14, wherein the plurality of processing threads are pre-subscribed to respective corresponding channels of the plurality of channels.

16. The method of claim 15, further comprising mapping of the plurality of processing threads and the corresponding plurality of channels each of the plurality of processing threads is pre-subscribed to.

17. The method of claim 9, wherein generating the commit channel comprises reallocating a previously-generated commit channel from a pool of previously-generated commit channels.

18. The method of claim 9, wherein a synchronization point of the plurality of synchronization points comprises a previously-generated synchronization point comprised in a pool of previously-generated synchronization points.

19. A non-transitory computer readable medium containing programmed instructions embodied therein, which when executed by a processor of a computing device, is operable to perform database actions in a database management system comprising a plurality of data partitions distributed among a plurality of remotely-located computing devices, the programmed instructions comprising:
instructions to receive a data-oriented transaction from a client computing device;
instructions to generate a commit channel and a execution plan for the transaction, the execution plan comprising a plurality of database actions organized into a plurality of phases separated by a plurality of synchronization points,
instructions to determine a subset of channels corresponding to the commit channel from a plurality of pre-existing channels;
instructions to subscribe a first plurality of processing threads to the commit channel;
instructions to publish database actions to be performed by the first plurality of processing threads;
instructions to receive notifications of the performance, in parallel, of a first set of database actions of the plurality of database actions corresponding to the first phase on a first set of data partitions of the plurality of data partitions;
instructions to publish a completion of the first set of actions to the commit channel; and
instructions to terminate the first phase in response to the completion of the first set of actions.

20. The non-transitory computer readable medium of claim 19, further comprising:
instructions to receive intermediate data resulting from the completion of the first set of actions;
instructions to subscribe a second plurality of processing threads to the commit channel such that the second plurality of processing threads is configured to receive notifications of database actions corresponding to the commit channel to be performed by the second plurality of processing threads, the second plurality of processing threads corresponding to a second phase of the plurality of sequential phases,
instructions to publish database actions to be performed by the second plurality of processing threads;
instructions to receive notifications of the performance, in parallel, of a second set of database actions of the plurality of database actions corresponding to the second phase on a second set of data partitions of the plurality of data partitions;
instructions to publish a completion of the second set of actions to the commit channel; and
instructions to terminate the second phase in response to the completion of the second set of actions.
